(19) United States
(12) Patent Application Publication
(10) Pub. No.: US 2010/0041804 A1
(43) Pub. Date: Feb. 18, 2010

(54) FABRICATING FIBERS

(76) Inventors: Gerrit J. Brands, Terneuzen (NL); Rene Broos, Bornem (BE); Rudolf J. Koopmans, Einsiedeln (CH)

Correspondence Address: The Dow Chemical Company, Intellectual Property Section, P.O. Box 1967, Midland, MI, 48641-1967, US

(21) Appl. No.: 12/539,788

(22) Filed: Aug. 12, 2009

Related U.S. Application Data
(60) Provisional application No. 61/088,532, filed on Aug. 13, 2008.

(51) Int. Cl. C08K 5/20

(52) U.S. Cl. 524/221

(57) ABSTRACT

The instant invention generally provides a process for fabricating fibers, preferably submicron fibers, from polymer melts containing one or more processing additives.

### CROSS-REFERENCE TO RELATED APPLICATION(S)

This application claims benefit of priority from U.S. Provisional Patent Application No. 61/088,532, filed Aug. 13, 2008, which application is incorporated by reference herein in its entirety.

The present invention is in the field of fibers and methods of fabricating fibers.

### BACKGROUND OF THE INVENTION

There is a need in the fiber art for improved processes of fabricating fibers from melts of polymers.

### SUMMARY OF THE INVENTION

The instant invention generally provides a process for fabricating fibers, preferably submicron fibers, from polymer melts containing one or more processing additives.

In a first embodiment, the instant invention is a process for fabricating a fiber comprising a molecularly self-assembling (MSA) material, the process comprising elongating under fiber-forming conditions a melt of a composition comprising a molecularly self-assembling material and one or more processing additives to produce one or more fibers comprising the molecularly self-assembling material, wherein the one or more processing additives comprise a total of from 1.0 weight percent (wt %) to 10 wt % of the composition and each processing additive independently is 1,1,2-trichloroethane; a (monohalo to perhalo)(C₇-C₄₀)alkyl; a (monohalo to perhalo)(C₃-C₄₀)cycloalkyl; a (monohalo to perhalo)phenyl; a (C₆-C₄₀)carboxylic ester of formula R²C(O)OR¹; a (C₆-C₄₀)carboxylic ester of formula R¹C(O)OR²; adipic acid dimethyl ester; adipic acid diethyl ester; an adipic acid dipropyl ester; maleic acid dimethyl ester; maleic acid diethyl ester; a maleic acid dipropyl ester; citric acid trimethyl ester; citric acid triethyl ester; a citric acid tripropyl ester; a (C₈-C₄₀)dicarboxylic ester of formula [R¹OC(O)](C₁-C₃)alkylene[C(O)OR²]; a (C₈-C₄₀)dicarboxylic ester of formula (C₄-C₄₀)alkylene[C(O)OR¹]₂; a (C₈-C₄₀)dicarboxylic ester of formula [R¹C(O)O](C₁-C₃)alkylene[C(O)OR²]; a (C₈-C₄₀)dicarboxylic ester of formula [R²C(O)O](C₁-C₃)alkylene[C(O)OR¹]; a (C₈-C₄₀)dicarboxylic ester of formula (C₄-C₄₀)alkylene[OC(O)R¹]₂; a (C₁₀-C₄₀)dicarboxylic ester of formula phenylene[C(O)OR¹]²; a (C₁₀-C₄₀)dicarboxylic ester of formula [R¹C(O)O]phenylene[C(O)OR¹]; a (C₁₀-C₄₀)dicarboxylic ester of formula phenylene[OC(O)R¹]₂; a (C₁₀-C₄₀)tricarboxylic ester of formula [R¹OC(O)]₂(C₁-C₃)alkylenyl[C(O)OR²]; a (C₁₀-C₄₀)tricarboxylic ester of formula (C₄-C₄₀)alkylenyl[C(O)OR¹]₃; a (C₁₀-C₄₀)tricarboxylic ester of formula [R¹C(O)O]₂(C₁-C₃)alkylenyl[OC(O)R²]; a (C₁₀-C₄₀)tricarboxylic ester of formula (C₄-C₄₀)alkylenyl[OC(O)R¹]₃; a (C₁₂-C₄₀)tricarboxylic ester of formula phenylenyl[C(O)OR¹]₃; a (C₁₂-C₄₀)tricarboxylic ester of formula [R¹C(O)O]phenylenyl[C(O)OR¹]₂; a (C₁₂-C₄₀)tricarboxylic ester of formula [R¹C(O)O]₂phenylenyl[C(O)OR¹]; a (C₁₂-C₄₀)tricarboxylic ester of formula phenylenyl[OC(O)R¹]₃; a (C₄-C₄₀)carboxylic acid of formula R²C(O)OH; a (C₄-C₄₀)carboxamide of formula R⁴C(O)NR⁵R⁶; a (C₃-C₄₀)alcohol of formula R⁷OH; bis(1-methylethyl)ketone; a (C₄-C₄₀)ketone of formula R⁸C(O)R⁹; 1,4-dioxane; a (C₄-C₄₀)ether of formula R⁸OR⁹; ethylene glycol; a propylene glycol; a butylene glycol; a (C₅-C₄₀)glycol of formula HO—(C₅-C₄₀)alkylene-OH; diethylene glycol; triethylene glycol; tetraethylene glycol; pentaethylene glycol; a (C₁₂-C₄₀)polyethylene glycol of formula HOCH₂CH₂(—OCH₂CH₂)ₘ—OH; dipropylene glycol; tripropylene glycol; tetrapropylene glycol; pentapropylene glycol; a (C₄-C₃₉)polypropylene glycol of formula HOCH₂CH₂CH₂(—OCH₂CH₂CH₂)ₙ—OH; glycerol; a methoxyglycerol; an ethoxyglycerol; a propoxyglycerol; an ethylene glycol mono(C₄-C₄₀)alkyl ether; a propylene glycol mono(C₄-C₄₀)alkyl ether; a (C₅-C₈₀)alkylene glycol monoalkyl ether of formula (C₁-C₄₀)alkylO—(C₄-C₄₀)alkylene-OH; 1,2-dimethoxyethane; 1,2-diethoxyethane; a 1,2-dipropoxyethane; dipropylene glycol dimethyl ether; a (C₆-C ₁₂₀)alkylene glycol dialkyl ether of formula (C₁-C₄₀)alkylO—(C₄-C₄₀)alkylene-O(C₁-C₄₀)alkyl; or a (C₃-C₁₂₀)triphosphate ester of formula P(O)(OR¹)₃; wherein independently for each processing additive: each m independently is an integer of from 5 to 19; each n independently is an integer of from 5 to 12; each halo independently is fluoro or chloro; each R¹ independently is (C₁-C₄₀)alkyl, (C₃-C₄₀)cycloalkyl, phenyl, or benzyl; each R² and R⁴ independently is (C₄-C₄₀)alkyl, (C₃-C₄₀)cycloalkyl, phenyl, or benzyl, or R¹ and R² are taken together form a (C₂-C₄₀)alkylene; each R⁵ and R⁶ independently is H, (C₁-C₄₀)alkyl, (C₃-C₄₀)cycloalkyl, phenyl, or benzyl, or R⁵ and R⁶ taken together form a (C₃-C₄₀)alkylene, or R⁴ and R⁵ are taken together form a (C₂-C₄₀)alkylene; each R⁷ independently is (C₄-C₄₀)alkyl, (C₃-C₄₀)cycloalkyl, phenyl, or benzyl; each R⁸ independently is (C₄-C₄₀)alkyl, (C₃-C₄₀)cycloalkyl, phenyl, or benzyl; each R⁹ independently is (C₁-C₄₀)alkyl, (C₃-C₄₀)cycloalkyl, phenyl, or benzyl, or R⁸ and R⁹ are taken together form a (C₇-C₄₀)alkylene; and each processing additive independently is unsubstituted or substituted by from 1 to 3 substituents, wherein each substituent independently is fluoro, chloro, —OH, —O(C₁-C₃)alkyl, —NH₂, —NH[(C₁-C₃)alkyl], —N[(C₁-C₃)alkyl]₂, or oxo.

In a second embodiment, the instant invention is a fiber prepared by the process of the first embodiment. In preferred aspects, at least one, preferably each of the one or more processing additives largely remain (i.e., greater than 50% of the added processing additive(s) remain), more preferably substantially remain (i.e., greater than 80% of the added processing additive(s) remain), still more preferably very substantially remain (i.e., greater than 90% of the added processing additive(s) remain) with the fiber. Preferably, amounts of processing additives remaining in the fiber are determined by nuclear magnetic resonance (NMR) (e.g., carbon-13 NMR or proton NMR). In other aspects, the processing additive(s) are fugitive processing additive(s), that is to say most of the processing additive(s) departs from the fiber during the invention process of the first embodiment.

In a third embodiment, the instant invention is an article comprising the fiber of the second embodiment. Preferably, the article is a bandage, medical gown, medical scaffold, cosmetic, sound insulation, barrier material, diaper coverstock, adult incontinence pants, training pants, underpad, feminine hygiene pad, wiping cloth, porous filter medium (e.g., for filtering air, gasses, or liquids), durable paper, fabric softener, home furnishing, floor covering backing, geotextile, apparel, apparel interfacing, apparel lining, shoe, industrial garment, agricultural fabric, automotive fabric, coating substrate, laminating substrate, leather, or electronic component.

Additional embodiments of the present invention are illustrated in the accompanying drawings and are described in the following detailed description and claims.

### BRIEF DESCRIPTION OF THE DRAWINGS

Figure (FIG.) 1 is a scanning electron microscope (SEM) image at 5000 times magnification of a fiberweb of Example 1.

### DETAILED DESCRIPTION OF THE INVENTION

The instant invention generally provides a process for fabricating fibers, preferably submicron fibers, from polymer melts containing one or more processing additives, wherein embodiments of the instant invention are summarized above. In any embodiment of the instant invention described herein, the open-ended terms “comprising,” “comprises,” and the like (which are synonymous with “including,” “having,” and “characterized by”) may be replaced by the respective partially closed phrases “consisting essentially of,” consists essentially of,” and the like or the respective closed phrases “consisting of,” “consists of,” and the like.

For purposes of United States patent practice and other patent practices allowing incorporation of subject matter by reference, and the entire contents—unless otherwise indicated—of each U.S. patent, U.S. patent application, U.S. patent application publication, PCT international patent application and WO publication equivalent thereof, referenced in the instant Detailed Description of the Invention are hereby incorporated by reference, especially with respect to the disclosure of synthetic techniques, reaction conditions, and compounds. When available, a U.S. patent or U.S. patent application publication family member thereof may be incorporated by reference instead of the PCT international patent application or WO publication equivalent. In an event where there is a conflict between what is written in the present specification and what is written in a patent, patent application, or patent application publication, or a portion thereof that is incorporated by reference, what is written in the present specification controls.

In the present application, any lower limit of a range, or any preferred lower limit of the range, may be combined with any upper limit of the range, or any preferred upper limit of the range, to define a preferred embodiment of the range.

In an event where there is a conflict between a value given in a U.S. unit (e.g., inches) and a value given in a standard international unit (e.g., centimeters), the U.S. unit value controls.

In the present application, when referring to a preceding list of elements (e.g., ingredients), the phrases “mixture thereof,” “combination thereof,” and the like mean any two or more of the listed elements.

The parenthetical expression of the form “(Cₚ-C_{q}),” means the chemical group comprises from a number x carbon atoms to a number y carbon atoms, wherein each p and q independently is an integer as described for the chemical group. Thus, for example, an unsubstituted (C₁-C₄₀)alkyl contains from 1 to 40 carbon atoms. When a substituent on the chemical group contains one or more carbon atoms, the substituted (Cₚ-C_{q}) chemical group comprises a total number of carbon atoms that is equal to q plus the number of carbon atoms, if any, of the substituent.

When used to describe the processing additive, the term “alkyl” (e.g., as in “(C₁-C₄₀)alkyl”) means a saturated straight or branched hydrocarbon radical that is unsubstituted or substituted. For illustration, examples of unsubstituted (C₁-C₄₀)alkyl are unsubstituted (C₁-C₂₀)alkyl; methyl; ethyl; 1-propyl; 2-propyl; 1-butyl; 2-butyl; 2-methylpropyl; 1,1-dimethylethyl; 1-pentyl; 1-hexyl; 1-heptyl; 1-nonyl; and 1-decyl. Examples of substituted (C₁-C₄₀)alkyl ar substituted (C₁-C₂₀)alkyl, and trifluoromethyl.

When used to describe the processing additive, the term “alkylene” means a saturated straight or branched chain diradical of that is unsubstituted or substituted. For illustration, examples of unsubstituted (C₁-C₃)alkylene are —CH₂—, —CH₂CH₂—, —(CH₂)₃—, and —CH₂>C(H)CH₃. Examples of substituted (C₁-C₃)alkylene are —CF₂— and —C(O)—.

When used to describe the processing additive, the term “alkylenyl” means a saturated straight or branched chain triradical of that is unsubstituted or substituted. For illustration, examples of unsubstituted (C₁-C₃)alkylenyl are >CH₂—, >CH₂CH₂—, >(CH₂)₃—, and >CH₂>C(H)CH₃. Examples of substituted (C₁-C₃)alkylenyl are >CF— and >C(OH)—.

When used to describe the processing additive, the term “cycloalkyl” means a saturated cyclic hydrocarbon radical that is unsubstituted or substituted. Examples of unsubstituted (C₃-C₄₀)cycloalkyl are unsubstituted (C₃-C₂₀)cycloalkyl, cyclopropyl, cyclobutyl, cyclopentyl, cyclohexyl, cycloheptyl, cyclooctyl, cyclononyl, and cyclodecyl. Examples of substituted (C₃-C₄₀)cycloalkyl are substituted (C₃-C₂₀)cycloalkyl, cyclopentanon-2-yl, and 1-fluorocyclohexyl.

The phrase “elongating under fiber-forming conditions” means subjecting a material to a means and environment for increasing the material's aspect ratio until the material at least becomes thread-, filament-, or fibril-like. Examples of the means for increasing the material's aspect ratio are extruding, fiber drawing, textile spinning, spun bonding, melt electrospinning, melt electroblowing, and melt blowing. Examples of the environment for increasing the material's aspect ratio are conventional processing parameters such as temperature, voltage, gas flow, pressure, collector distance, atmosphere, and the like that are useful for extruding, fiber drawing, textile spinning, spun bonding, melt electrospinning, melt electroblowing, or melt blowing a melt of a polymer.

The term “phenylene” means an unsubstituted or substituted diradical of benzene. The term “phenylenyl” means an unsubstituted or substituted triradical of benzene.

The term “poly” as in “polyfluoro” means that two or more H, but not all H, bonded to carbon atoms of a corresponding unsubstituted chemical group are replaced by a fluoro (i.e., such that a “C—H” becomes a “C—F”). The term “per” as in “perfluoro” means each H bonded to carbon atoms of a corresponding unsubstituted chemical group is replaced by a fluoro.

The terms “polyalkylene glycol” and “polyalkylene oxide” are synonymous and generally mean a compound of formula HO-alkylene(-O-alkylene)ₙ—OH, wherein n is an integer of 5 or more.

The term “processing additive” refers to a substance that (a) reduces viscosity of a melt of a MSA material compared to viscosity of the MSA material lacking the substance, (b) allows production of smaller average diameter fibers from a melt of a composition comprising the processing additive and the MSA material compared to average diameter of fibers produced from a melt of the MSA material lacking a processing additive under essentially equivalent processing conditions, (c) allows higher fiber production rates (weight of fiber(s) produced per unit time) from a melt of a composition comprising the processing additive and the MSA material compared to fiber production rates of a melt of the MSA material lacking a processing additive under essentially equivalent processing conditions, (d) allows production of fibers from a melt of a composition comprising the processing additive and the MSA material at lower temperatures compared to temperatures of a melt of the MSA material lacking a processing additive under essentially equivalent processing conditions, (e) increases electrical conductivity of the melt, (f) reduces surface tension of the melt, (g) improves wetting of a spinning electrode, or a combination of any two or more thereof.

Based on what we know now, we would expect viscosity cutters, wetting agents and ‘conductivity improvers’ to have most of the effects or any combination thereof.

The term “viscosity” means zero shear viscosity unless specified otherwise. The term “T_{g}” means glass transition temperature. The term “Tₘ” means melting temperature (i.e., melting point) as determined by techniques known in the art such as differential scanning calorimetry. If a MSA material has one or more Tₘ, preferably at least one Tₘ is 25° C. or higher.

Preferably, the melt of the composition is characterized as having a viscosity that is less than a viscosity of a melt consisting essentially of the molecularly self-assembling material, wherein each viscosity is determined at a temperature that is the higher of 10 degrees Celsius (° C.) above glass transition temperature (T_{g}) or above melting temperature (Tₘ) of the molecularly self-assembling material without any processing additive. Also preferably, the viscosity of the melt of the composition is more than 5 percent (%) lower, more preferably more than 10% lower, still more preferably more than 20% lower than the viscosity of the melt consisting essentially of the molecularly self-assembling material.

### Molecularly Self-Assembling Material

As used herein, a MSA material useful in the present invention means an oligomer or polymer that effectively forms larger associated or assembled oligomers and/or polymers through the physical intermolecular associations of chemical functional groups. Without wishing to be bound by theory, it is believed that the intermolecular associations do not increase the molecular weight (Mn-Number Average molecular weight) or chain length of the self-assembling material and covalent bonds between said materials do not form. This combining or assembling occurs spontaneously upon a triggering event such as cooling to form the larger associated or assembled oligomer or polymer structures. Examples of other triggering events are the shear-induced crystallizing of, and contacting a nucleating agent to, a molecularly self-assembling material. Accordingly, in preferred embodiments MSAs exhibit mechanical properties similar to some higher molecular weight synthetic polymers and viscosities like very low molecular weight compounds. MSA organization (self-assembly) is caused by non-covalent bonding interactions, often directional, between molecular functional groups or moieties located on individual molecular (i.e. oligomer or polymer) repeat units (e.g. hydrogen-bonded arrays). Non-covalent bonding interactions include: electrostatic interactions (ion-ion, ion-dipole or dipole-dipole), coordinative metal-ligand bonding, hydrogen bonding, π-π-structure stacking interactions, donor-acceptor, and/or van der Waals forces and can occur intra- and intermolecularly to impart structural order. One preferred mode of self-assembly is hydrogen-bonding and this non-covalent bonding interactions is defined by a mathematical “Association constant”, K(assoc) constant describing the relative energetic interaction strength of a chemical complex or group of complexes having multiple hydrogen bonds. Such complexes give rise to the higher-ordered structures in a mass of MSA materials. A description of self assembling multiple H-bonding arrays can be found in “Supramolecular Polymers”, Alberto Ciferri Ed., 2nd Edition, pages (pp) 157-158. A “hydrogen bonding array” is a purposely synthesized set (or group) of chemical moieties (e.g. carbonyl, amine, amide, hydroxyl. etc.) covalently bonded on repeating structures or units to prepare a self assembling molecule so that the individual chemical moieties preferably form self assembling donor-acceptor pairs with other donors and acceptors on the same, or different, molecule. A “hydrogen bonded complex” is a chemical complex formed between hydrogen bonding arrays. Hydrogen bonded arrays can have association constants K (assoc) between 10² and 10⁹ M⁻¹ (reciprocal molarities), generally greater than 10³ M⁻¹. In preferred embodiments, the arrays are chemically the same or different and form complexes.

Accordingly, the molecularly self-assembling materials (MSA) suitable for melt-blowing presently include: molecularly self-assembling polyesteramides, copolyesteramide, copolyetheramide, copolyetherester-amide, copolyetherester-urethane, copolyether-urethane, copolyester-urethane, copolyester-urea, copolyetherester-urea and their mixtures. Preferred MSA include copolyesteramide, copolyether-amide, copolyester-urethane, and copolyether-urethanes. The MSA preferably has number average molecular weights, MWₙ (interchangeably referred to as Mₙ) (as is preferably determined by NMR spectroscopy) of 2000 grams per mole or more, more preferably at least about 3000 g/mol, and even more preferably at least about 5000 g/mol. The MSA preferably has MWₙ 50,000 g/mol or less, more preferably about 20,000 g/mol or less, yet more preferably about 15,000 g/mol or less, and even more preferably about 12,000 g/mol or less. The MSA material preferably comprises molecularly self-assembling repeat units, more preferably comprising (multiple) hydrogen bonding arrays, wherein the arrays have an association constant K (assoc) preferably from 10² to 10⁹ reciprocal molarity (M⁻¹) and still more preferably greater than 10⁻³ M⁻¹; association of multiple-hydrogen-bonding arrays comprising donor-acceptor hydrogen bonding moieties is the preferred mode of self assembly. The multiple H-bonding arrays preferably comprise an average of 2 to 8, more preferably 4-6, and still more preferably at least 4 donor-acceptor hydrogen bonding moieties per molecularly self-assembling unit. Molecularly self-assembling units in preferred MSA materials include bis-amide groups, and bis-urethane group repeat units and their higher oligomers.

Preferred self-assembling units in the MSA material useful in the present invention are bis-amides, bis-urethanes and bis-urea units or their higher oligomers. A more preferred self-assembling unit comprises a poly(ester-amide), poly(ether-amide), poly(ester-urea), poly(ether-urea), poly(ester-urethane), or poly(ether-urethane), or a mixture thereof. For convenience and unless stated otherwise, oligomers or polymers comprising the MSA materials may simply be referred to herein as polymers, which includes homopolymers and interpolymers such as co-polymers, terpolymers, etc.

In some embodiments, the MSA materials include “non-aromatic hydrocarbylene groups” and this term means specifically herein hydrocarbylene groups (a divalent radical formed by removing two hydrogen atoms from a hydrocarbon) not having or including any aromatic structures such as aromatic rings (e.g. phenyl) in the backbone of the oligomer or polymer repeating units. In some embodiments, non-aromatic hydrocarbylene groups are optionally substituted with various substituents, or functional groups, including but not limited to: halides, alkoxy groups, hydroxy groups, thiol groups, ester groups, ketone groups, carboxylic acid groups, amines, and amides. A “non-aromatic heterohydrocarbylene” is a hydrocarbylene that includes at least one non-carbon atom (e.g. N, O, S, P or other heteroatom) in the backbone of the polymer or oligomer chain, and that does not have or include aromatic structures (e.g., aromatic rings) in the backbone of the polymer or oligomer chain. In some embodiments, non-aromatic heterohydrocarbylene groups are optionally substituted with various substituents, or functional groups, including but not limited to: halides, alkoxy groups, hydroxy groups, thiol groups, ester groups, ketone groups, carboxylic acid groups, amines, and amides. Heteroalkylene is an alkylene group having at least one non-carbon atom (e.g. N, O, S or other heteroatom) that, in some embodiments, is optionally substituted with various substituents, or functional groups, including but not limited to: halides, alkoxy groups, hydroxy groups, thiol groups, ester groups, ketone groups, carboxylic acid groups, amines, and amides. For the purpose of this disclosure, a “cycloalkyl” group is a saturated carbocyclic radical having three to twelve carbon atoms, preferably three to seven. A “cycloalkylene” group is an unsaturated carbocyclic radical having three to twelve carbon atoms, preferably three to seven. Cycloalkyl and cycloalkylene groups independently are monocyclic or polycyclic fused systems as long as no aromatics are included. Examples of carbocyclic radicals include cyclopropyl, cyclobutyl, cyclopentyl, cyclohexyl and cycloheptyl. In some embodiments, the groups herein are optionally substituted in one or more substitutable positions as would be known in the art. For example in some embodiments, cycloalkyl and cycloalkylene groups are optionally substituted with, among others, halides, alkoxy groups, hydroxy groups, thiol groups, ester groups, ketone groups, carboxylic acid groups, amines, and amides. In some embodiments, cycloalkyl and cycloalkene groups are optionally incorporated into combinations with other groups to form additional substituent groups, for example: “-Alkylene-cycloalkylene-, “-alkylene-cycloalkylene-alkylene-”, “-heteroalkylene-cycloalkylene-”, and “-heteroalkylene-cycloalkyl-heteroalkylene” which refer to various non-limiting combinations of alkyl, heteroalkyl, and cycloalkyl. These combinations include groups such as oxydialkylenes (e.g., diethylene glycol), groups derived from branched diols such as neopentyl glycol or derived from cyclo-hydrocarbylene diols such as Dow Chemical's UNOXOLG isomer mixture of 1,3- and 1,4-cyclohexanedimethanol, and other non-limiting groups, such -methylcylohexyl-, -methyl-cyclohexyl-methyl-, and the like. “Heterocycloalkyl” is one or more cyclic ring systems having 4 to 12 atoms and containing carbon atoms and at least one and up to four heteroatoms selected from nitrogen, oxygen, or sulfur. Heterocycloalkyl includes fused ring structures. Preferred heterocyclic groups contain two ring nitrogen atoms, such as piperazinyl. In some embodiments, the heterocycloalkyl groups herein are optionally substituted in one or more substitutable positions. For example in some embodiments, heterocycloalkyl groups are optionally substituted with halides, alkoxy groups, hydroxy groups, thiol groups, ester groups, ketone groups, carboxylic acid groups, amines, and amides.

Examples of MSA materials useful in the present invention are poly(ester-amides), poly(ether-amides), poly(ester-ureas), poly(ether-ureas), poly(ester-urethanes), and poly(ether-urethanes), and mixtures thereof that are described, with preparations thereof, in United States Patent Number (USPN) U.S. Pat. No. 6,172,167; and applicant's co-pending PCT application numbers PCT/US2006/023450, which was renumbered as PCT/US2006/004005 and published under PCT International Patent Application Number (PCT-IPAPN) WO 2007/099397; PCT/US2006/035201, which published under PCT-IPAPN WO 2007/030791; PCT/US08/053917; PCT/US08/056754; and PCT/US08/065242. Preferred said MSA materials are described below.

In a set of preferred embodiments, the molecularly self-assembling material comprises ester repeat units of Formula I:

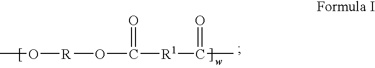

and at least one second repeat unit selected from the esteramide units of Formula II and III:

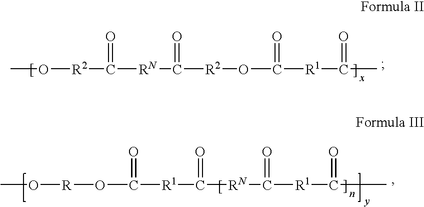

and the ester-urethane units of Formula IV:

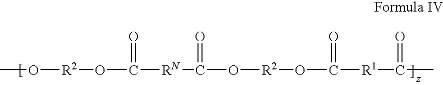

wherein

R is at each occurrence, independently a C₂-C₂₀ non-aromatic hydrocarbylene group, a C₂-C₂₀ non-aromatic heterohydrocarbylene group, or a polyalkylene oxide group having a group molecular weight of from about 100 to about 5000 g/mol. In preferred embodiments, the C₂-C₂₀ non-aromatic hydrocarbylene at each occurrence is independently specific groups: alkylene-, -cycloalkylene-, -alkylene-cycloalkylene-, -alkylene-cycloalkylene-alkylene-(including dimethylene cyclohexyl groups). Preferably, these aforementioned specific groups are from 2 to 12 carbon atoms, more preferably from 3 to 7 carbon atoms. The C₂-C₂₀ non-aromatic heterohydrocarbylene groups are at each occurrence, independently specifically groups, non-limiting examples including: -hetereoalkylene-, -heteroalkylene-cycloalkylene-, -cycloalkylene-heteroalkylene-, or -heteroalkylene-cycloalkylene-heteroalkylene-, each aforementioned specific group preferably comprising from 2 to 12 carbon atoms, more preferably from 3 to 7 carbon atoms. Preferred heteroalkylene groups include oxydialkylenes, for example diethylene glycol (—CH₂CH₂OCH₂CH₂—O—). When R is a polyalkylene oxide group it preferably is a polytetramethylene ether, polypropylene oxide, polyethylene oxide, or their combinations in random or block configuration wherein the molecular weight (Mn-average molecular weight, or conventional molecular weight) is preferably about 250 g/ml to 5000, g/mol, more preferably more than 280 g/mol, and still more preferably more than 500 g/mol, and is preferably less than 3000 g/mol; in some embodiments, mixed length alkylene oxides are included. Other preferred embodiments include species where R is the same C₂-C₆ alkylene group at each occurrence, and most preferably it is —(CH₂)₄—.

R¹ is at each occurrence, independently, a bond, or a C₁-C₂₀ non-aromatic hydrocarbylene group. In some preferred embodiments, R¹ is the same C₁-C₆ alkylene group at each occurrence, most preferably —(CH₂)₄—.

R² is at each occurrence, independently, a C₁-C₂₀ non-aromatic hydrocarbylene group. According to another embodiment, R²is the same at each occurrence, preferably C₁-C₆ alkylene, and even more preferably R² is —(CH₂)₂—, —(CH₂)₃—, —(CH₂)₄—, or —(CH₂)₅—.

R^{N} is at each occurrence —N(R³)—Ra—N(R³)—, where R³ is independently H or a C₁-C₆ alkyl, preferably C₁-C₄ alkyl, or R^{N} is a C₂-C₂₀ heterocycloalkylene group containing the two nitrogen atoms, wherein each nitrogen atom is bonded to a carbonyl group according to Formula II or III above; w represents the ester mol fraction, and x, y and z represent the amide or urethane mole fractions where w+x+y+z=1, 0<w<1, and at least one of x, y and z is greater than zero. Ra is a C₂-C₂₀ non-aromatic hydrocarbylene group, more preferably a C₂-C₁₂ alkylene: most preferred Ra groups are ethylene butylene, and hexylene —(CH₂)₆—. In some embodiments, R^{N} is piperazin-1,4-diyl. According to another embodiment, both R³ groups are hydrogen.

n is at least 1 and has a mean value less than 2.

In an alternative embodiment, the MSA is a polymer consisting of repeat units of either Formula II or Formula III, wherein R, R¹, R², R^{N}, and n are as defined above and x and y are mole fractions wherein x+y=1, and 0≦x≦1 and 0≦y≦1.

In certain embodiments comprising polyesteramides of Formula I and II, or Formula I, II, and III, particularly preferred materials are those wherein R is —(C₂-C₆)-alkylene, especially —(CH₂)₄—. Also preferred are materials wherein R¹ at each occurrence is the same and is C₁-C₆ alkylene, especially —(CH₂)₄—. Further preferred are materials wherein R² at each occurrence is the same and is —(C₁-C₆)-alkylene, especially —(CH₂)₅-alkylene. The polyesteramide according to this embodiment preferably has a number average molecular weight (Mn) of at least about 4000, and no more than about 20,000. More preferably, the molecular weight is no more than about 12,000.

For convenience the chemical repeat units for various embodiments are shown independently. The invention encompasses all possible distributions of the w, x, y, and z units in the copolymers, including randomly distributed w, x, y and z units, alternatingly distributed w, x, y and z units, as well as partially, and block or segmented copolymers, the definition of these kinds of copolymers being used in the conventional manner as known in the art. Additionally, there are no particular limitations in the invention on the fraction of the various units, provided that the copolymer contains at least one w and at least one x, y, or z unit. In some embodiments, the mole fraction of w to (x+y+z) units is between about 0.1:0.9 and about 0.9:0.1. In some preferred embodiments, the copolymer comprises at least 15 mole percent w units, at least 25 mole percent w units, or at least 50 mole percent w units.

In some embodiments, the number average molecular weight (Mₙ) of the MSA material useful in the present invention is between 1000 g/mol and 30,000 g/mol, inclusive. In some embodiments, Mₙ of the MSA material is between 2,000 g/mol and 20,000 g/mol, inclusive, preferably 5,000 g/mol to 12,000 g/mol. In more preferred embodiments, Mₙ of the MSA material is less than 5,000 g/mol. Thus, in some more preferred embodiments, Mₙ of the MSA material is at least about 1000 g/mol and 4,900 g/mol or less, more preferably 4,500 g/mol or less.

For preparing fibers comprising the MSA material useful in the present invention, viscosity of a melt of a preferred MSA material is characterized as being Newtonian over the frequency range of 10⁻to 10² radians per second (rad./s.) at a temperature from above a melting temperature Tₘ up to about 40 degrees Celsius (° C.) above Tₘ, preferably as determined by differential scanning calorimetry (DSC). Depending upon the polymer or oligomer, preferred MSA materials exhibit Newtonian viscosity in the test range frequency at temperatures above 100° C., more preferably above 120° C. and more preferably still at or above 140° C. and preferably less than 300° C., more preferably less than 250° C. and more preferably still less than 200° C. For the purposes of the present disclosure, the term Newtonian has its conventional meaning; that is, approximately a constant viscosity with increasing (or decreasing) shear rate of a (MSA) material at a constant testing temperature. The MSA materials, preferably having Mₙ less than 5,000 g/mol, advantageously possess low melt viscosities useful for high output (relative to traditional high polymer electrospinning) fiber electrospinning and fiber melt blowing and utilities in submicron-fiber form. The zero shear viscosity of a preferred MSA material is in the range of from 0.1 Pa.s. to 1000 Pa.s., preferably from 0.1 Pa.s. to 100 Pa.s., more preferably from 0.1 to 30 Pa.s., still more preferred 0.1 Pa.s. to 10 Pa.s., in the temperature range of 180° C. and 220° C., e.g., 180° C. and 190° C.

Preferably, the viscosity of a melt of a MSA material useful in the present invention is less than 100 Pa.s. at from above Tₘ up to about 40° C. above Tₘ. The viscosity of one of the preferred MSA materials is less than 100 Pa.s. at 190° C., and more preferably in the range of from 1 Pa.s. to 50 Pa.s. at 150° C. to 170° C. Preferably, the glass transition temperature of the MSA material is less than 20° C. Preferably, the melting point is higher than 60° C. Preferred MSA materials exhibit multiple glass transition temperatures T_{g}. Preferably, the MSA material has a T_{g} that is higher than −80° C. Also preferably, the MSA material has a T_{g} that is higher than −60° C.

For preparing the fibers, especially by melt electrospinning or melt blowing, the tensile modulus of one preferred group of MSA materials useful in the invention is preferably from 4 megapascals (MPa) to 500 MPa at room temperature, preferably 20° C. Tensile modulus testing is well known in the polymer arts.

Preferably, the torsional (dynamic) storage modulus of MSA materials useful in the invention is 12 MPa, more preferably at least 50 MPa, still more preferably at least 100 MPa, all at 20° C. Preferably, the storage modulus is 400 MPa or lower, more preferably 300 MPa or lower, still more preferably 250 MPa or lower, or still more preferably about 200 MPa or lower, all at 20° C.

Preferably, polydispersities of substantially linear MSA materials useful in the present invention is 4 or less, more preferably 3 or less, still more preferably 2.5 or less, still more preferably 2.2 or less.

In some embodiments, the polymers described herein are modified with, for example and without limitation thereto, other polymers, resins, tackifiers, fillers, oils and additives (e.g. flame retardants, antioxidants, pigments, dyes, and the like).

### Processing Additives

In some embodiments, the processing additive useful in the present invention preferably is any one member of the following list: 1,1,2-trichloroethane; adipic acid dimethyl ester; adipic acid diethyl ester; an adipic acid dipropyl ester; maleic acid dimethyl ester; maleic acid diethyl ester; a maleic acid dipropyl ester; citric acid trimethyl ester; citric acid triethyl ester; a citric acid tripropyl ester; bis(l-methylethyl)ketone; 1,4-dioxane; ethylene glycol; a propylene glycol; a butylene glycol; diethylene glycol; triethylene glycol; tetraethylene glycol; pentaethylene glycol; dipropylene glycol; tripropylene glycol; tetrapropylene glycol; pentapropylene glycol; glycerol; a methoxyglycerol; an ethoxyglycerol; a propoxyglycerol; 1,2-dimethoxyethane; 1,2-diethoxyethane; a 1,2-dipropoxyethane; and dipropylene glycol dimethyl ether. In other embodiments, the processing additive is any one member of the aforementioned list, wherein the list lacks any five, preferably any four, more preferably any three, still more preferably any two, and even more preferably any one of the aforementioned members.

In other embodiments, a processing additive useful in the present invention preferably is any one group of the following list: a (monohalo to perhalo)(C₇-C₄₀)alkyl; a (monohalo to perhalo)(C₃-C₄₀)cycloalkyl; a (monohalo to perhalo)phenyl; a (C₆-C₄₀)carboxylic ester of formula R²C(O)OR¹; a (C₆-C₄₀)carboxylic ester of formula R¹C(O)OR²; a (C₈-C₄₀)dicarboxylic ester of formula [R¹OC(O)](C₁-C₃)alkylene[C(O)OR²]; a (C₈-C₄₀)dicarboxylic ester of formula (C₄-C₄₀)alkylene[C(O)OR¹]₂; a (C₈-C₄₀)dicarboxylic 10 ester of formula [R¹C(O)O](C₁-C3)alkylene[C(O)OR²]; a (C₈-C₄₀)dicarboxylic ester of formula [R² C(O)O](C₁-C₃)alkylene[C(O)OR¹]; a (C₈-C₄₀)dicarboxylic ester of formula (C₄-C₄₀)alkylene[OC(O)R^{1]}₂; a (C₁₀-C₄₀)dicarboxylic ester of formula phenylene[C(O)OR¹]₂; a (C₁₀-C₄₀)dicarboxylic ester of formula [R¹C(O)O]phenylene[C(O)OR¹]; a (C₁₀-C₄₀)dicarboxylic ester of formula phenylene[OC(O)R^{1]}₂; a (C₁₀-C₄₀)tricarboxylic ester of formula [R¹OC(O)]₂(C₁-C₃)alkylenyl[C(O)OR²]; a (C₁₀-C₄₀)tricarboxylic ester of formula (C₄-C₄₀)alkylenyl[C(O)OR¹]₃; a (C₁₀-C₄₀)tricarboxylic ester of formula [R¹C(O)O]₂(C₁-C₃)alkylenyl[OC(O)R²]; a (C₁₀-C₄₀)tricarboxylic ester of formula (C₄-C₄₀)alkylenyl[OC(O)R¹]₃; a (C₁₂-C₄₀)tricarboxylic ester of formula phenylenyl[C(O)OR¹]₃; a (C₁₂-C₄₀)tricarboxylic ester of formula [R¹C(O)O]phenylenyl[C(O)OR¹]₂; a (C₁₂-C₄₀)tricarboxylic ester of formula [R¹C(O)O]₂phenylenyl[C(O)OR¹]; a (C₁₂-C₄₀)tricarboxylic ester of formula phenylenyl[OC(O)R¹]₃; a (C₄-C₄₀)carboxylic acid of formula R²C(O)OH; a (C₄-C₄₀)carboxamide of formula R⁴C(O)NR⁵R⁶; a (C₃-C₄₀)alcohol of formula R⁷OH; a (C₄-C₄₀)ketone of formula R⁸C(O)R⁹; a (C₄-C₄₀)ether of formula R⁸OR⁹; a (C₅-C₄₀)glycol of formula HO—(C₅-C₄₀)alkylene-OH; a (C₁₂-C₄₀)polyethylene glycol of formula HOCH₂CH₂(—OCH₂CH₂)ₘ—OH; a (C₄-C₃₉)polypropylene glycol of formula HOCH₂CH₂CH₂(—OCH₂CH₂CH₂)ₙ—OH; an ethylene glycol mono(C₄-C₄₀)alkyl ether; a propylene glycol mono(C₄-C₄₀)alkyl ether; a (C₅-C₈₀)alkylene glycol monoalkyl ether of formula (C₁-C₄₀)alkylO—(C₄-C₄₀)alkylene-OH; a (C₆-C₁₂₀)alkylene glycol dialkyl ether of formula (C₁-C₄₀)alkylO—(C₄-C₄₀)alkylene-O(C₁-C₄₀)alkyl; and a (C₃-C₁₂₀)triphosphate ester of P(O)(OR¹)₃. In other embodiments, the processing additive is any one group of the aforementioned 5 list, wherein the list lacks any five, preferably any four, more preferably any three, still more preferably any two, and even more preferably any one of the aforementioned groups.

In still other embodiments, a processing additive useful in the present invention preferably is a butanol, a pentanol, a hexanol, a heptanol, an octanol, benzyl alcohol, a polyethylene glycol having an average molecular weight of about 200 grams per mole (g/mol), or a polypropylene glycol having an average molecular weight of about 400 g/mol.

In some embodiments, the number of carbon atoms in each processing additive independently is 10 or more.

Preferably, the one or more processing additives comprise a total of from about 2 weight percent (wt %) to about 6 wt % of the composition.

### Fibers Comprising MSA Material Useful in the Present Invention

Fibers comprising MSA material useful in the present invention are fabricated under fiber-forming conditions such as, for example, extruding, fiber drawing, textile spinning, spun bonding, melt electrospinning, melt electroblowing, and melt blowing. Preferably, the fiber-forming condition is melt blowing or melt electrospinning. Preferably, fibers comprising the MSA material are fabricated with a fiber-fabricating device, wherein the device is more preferably a spun bonding device, melt electrospinning device, melt blowing device, or electroblowing device. Fibers having an average diameter of from about 1.5 μm to about 10 μm are preferentially prepared via melt blowing. Fibers having an average diameter of from about 10 μm to about 30 μm are preferentially prepared via spun bond fibers.

In preferred embodiments of the present invention, the fibers prepared by a method of the present invention have an average diameter of from about 0.010 μm to about 30 μm. In some embodiments of the present invention, the average diameter is at least about 0.10 μm. In other embodiments, the average diameter is at least about 200 μm, at least about 1.5 μm, or at least about 10 μm. In some embodiments of the present invention, the average diameter is about 20 μm or less. In other embodiments, the average diameter is about 10 μm or less, about 1.5 μm or less, or about 1.0 μm or less.

Producing Fibers comprising the MSA Materials Useful in the Present Invention by Melt Electrospinning

In a typical melt electrospinning process for producing fibers comprising an MSA material useful in the present invention, the melt of the composition comprising MSA material and one or more processing additives is fed into or onto the spinneret from, for example, the syringe at a constant and controlled rate using a metering pump. A high voltage (e.g., 1 kV to 120 kV) is applied and the drop of composition at the nozzle of the syringe becomes highly electrified. At a characteristic voltage the droplet forms a Taylor cone, and a fine jet of composition develops. The fine composition jet is drawn to the conductor (e.g., a grounded conductor), which is placed opposing the spinneret. While being drawn to the conductor, the jet cools and hardens into fibers. Preferably, the fibers are deposited on a collector that is placed in front of the conductor. In some embodiments, fibers are deposited on the collector as a randomly oriented, non-woven mat or individually captured and wound-up on a roll. The fibers are subsequently stripped from the collector if desired. In other embodiments, a charged conductor (opposite polarity to that of electrode) is employed instead of the grounded conductor.

The parameters for operating the electrospinning apparatus for effective melt spinning of the composition useful in the present invention may be readily determined by a person of ordinary skill in the art without undue experimentation. By way of example, the spinneret is generally heated up to about 300° C., the spin electrode temperature is maintained at about 10° C. or higher (e.g., up to just below a decomposition temperature of the composition or up to about 150° C. higher) above the melting point or temperature at which the composition has sufficiently low viscosity to allow thin fiber formation, and the surrounding environmental temperature is unregulated or, optionally, heated (e.g., maintained at about similar temperatures using hot air). Alternatively, the spinneret is generally heated up to about 300° C. and the surrounding environmental temperature optionally is maintained at about room temperature (i.e., from about 20° C to 30° C.). The applied voltage is generally about 1 kV to 120 kV, preferably 1 kV to 80 kV. The electrode gap (the gap between spin electrode and collector) is generally between about 3 cm and about 50 cm, preferably about 3 cm and about 19 cm. Preferably, the fibers are fabricated at about ambient pressure (e.g., 1.0 atmosphere) although the pressure may be higher or lower. Preferred electrospinning devices are those that are marketed commercially as being useful for melt electrospinning. Use of commercially available melt electrospinning device such as NS Lab M device, Elmarco s.r.o., Liberec, Czech Republic (e.g., using Nanospider™ technology), are more preferred.

The fibers comprising the MSA material useful in the present invention that are prepared by a melt electrospinning process described herein generally have an average diameter of about 1000 nm or less, more preferably about 800 nm or less, and more preferably about 600 nm or less. Preferably, the average diameter of the fibers is at least 100 nm, more preferably at least 200 nm. In other aspects, the fibers have an average diameter of about 30 nm to about 1000 nm, more preferably about 200 nm to about 600 nm. In other aspects, the fibers have an average diameter of about 50 nm to about 1000 nm. In some embodiments, fibers are fabricated with diameters as low as about 30 nm. Particularly preferred are coating fibers with average diameters of about 200 nm to 300 nm.

A melt electrospinning process described above produces fibers comprising the MSA material useful in the present invention without beading.

### Producing Fibers Comprising the MSA Material Useful in the Present Invention by Melt Blowing

A melt blowing device typically comprises at least one die block having a portion that functions as a die tip; at least one gas knife assembly; a source of a stretch gas stream; and a collector, wherein the source of a stretch gas stream independently is in operative fluid communication with the gas knife assembly and the die tip. The die tip defines at least one, preferably a plurality of, apertures through which a melt of a material to be melt blown passes. A source of the melt is in operative fluid communication with the apertures of the die tip. Examples of useful stretch gases are air, nitrogen, argon, helium, and a mixture of any two or more thereof. Preferably, the stretch gas is air, nitrogen, or a mixture thereof; more preferably the stretch gas is air. An example of a melt blowing device is an Oerlikon Neumag Meltblown Technology™ system (Oerlikon Heberlein Wattwil AG, Switzerland). Preferably, the stretch gas is air sourced from a compressed air chamber and temperature of the stretch gas is measured in the compressed air chamber.

The invention herein may use any melt blowing system but preferably uses specialized process melt-blowing systems produced by Hills, Inc. of West Melbourne, Fla. 32904. See e.g. U.S. Pat. No. 6,833,104 B2, and WO 2007/121458 A2 the teachings of each of which are hereby incorporated by reference. See also www.hillsinc.net/technology.shtml and www.hillsinc.neti/nanomeltblownfibric.shtml and the article “Potential of Polymeric Nanofibers for Nonwovens and Medical Applications” by Dr John Hagewood, J. Hagewood, LLC, and Ben Shuler, Hills, Inc, published in the 26 February 2008 Volume of Fiberjournal.com. Preferred dies have very large Length/Diameter flow channel ratios (L/D) in the range of greater than 20/1 to 1000/1, preferably greater than 100/1 to 1000/1, including for example, but not limited to, L/D values 150/1, 200/1, 250/1, 300/1 and the like so long as there is sufficient polymer back pressure for even polymer flow distribution. Additionally, the die spinholes (“holes”) are typically on the order of 0.05 to 0.2 mm in diameter.

For purposes of the present invention, average fiber diameter for a plurality of fibers is determined by processing a scanning electron microscope (SEM) image thereof with, for example, a QWin image analysis system (Leica Microsystems GmbII, 35578 Wezlar, Germany).

Carbon-13 nuclear magnetic resonance (¹³C-NMR) or, preferably, proton nuclear magnetic resonance spectroscopy (proton NMR or ¹II-NMR) is used to determine monomer purity, MSA copolymer composition, and MSA copolymer number average molecular weight Mₙ utilizing the CH₂OH end groups. Proton NMR assignments are dependent on the specific structure being analyzed as well as the solvent, concentration, and temperatures utilized for measurement. For ester amide monomers and co-polyesteramides, d4-acetic acid is a convenient solvent and is the solvent used unless otherwise noted. For ester amide monomers of the type called DD that are methyl esters typical peak assignments are about 3.6 to 3.7 ppm for C(═O)—OCH₃; about 3.2 to 3.3 ppm for N—CH₂—; about2.2 to 2.4 ppm for C(═O)—CH₂—; and about 1.2 to 1.7 ppm for C—CH₂—C. For co-polyesteramides that are based on DD with 1,4-butanediol, typical peak assignments are about 4.1 to 4.2 ppm for C(═O)—OCH₂—; about3.2 to 3.4 ppm for N—CH₂—; about 2.2 to 2.5 ppm for C(═O)—CH₂—; about 1.2 to 1.8 ppm for C—CH₂—C, and about 3.6 to 3.75 —CH₂OH end groups.

### Preparations

Preparation 1: preparation of MSA material that is a polyesteramide (PEA) comprising 50 mole percent of ethylene-N,N′-dihydroxyhexanamide (C2C) monomer (the MSA material is generally designated as a PEA-C2C50%)

Step (a) Preparation of the Diamide Diol Monomer, ethylene-N,N′-dihydroxyhexanamide (C2C)

A 10-liter (L) stainless steel reactor equipped with an agitator and a cooling water jacket is charged with 8-caprolactone (5.707 kilograms (kg), 50 moles) and purged with nitrogen. Under rapid stirring, ethylene diamine (EDA; 1.502 kg, 25 moles) is added at once. After an induction period a slow exothermic reaction starts. The reactor temperature gradually rises to 90° C. under maximum cooling applied. A white deposit forms and the reactor contents solidify, at which point stirring is stopped. The reactor contents are then cooled to 20° C. and are then allowed to rest for 15 hours. The reactor contents are then heated to 140° C. (at which temperature the solidified reactor contents melt), and heated then further to 160° C. under continued stirring for at least 2 hours. The resulting liquid product is then discharged from the reactor into a collecting tray. A nuclear magnetic resonance study of the resulting product shows that the molar concentration of C2C in the product exceeds 80 per cent. The procedure is repeated four more times resulting in five product lots. The melting point of the product is determined to be 130-140° C. (main melting point) by differential scanning calorimetry (DSC) (peak maximum). The solid material is granulated and used without further purification.

Step (b): Preparation of PEA-C2C50% of Preparation 1

A 2.5 L, single-shaft kneader/devolatizer reactor equipped with distillation column, feed cylinders and vacuum pump system is charged at room temperature or 50° C. to 60° C. with 0.871 kg of dimethyl adipate (DMA) and 0.721 kg of C2C (granulated, of step (a)), under a nitrogen atmosphere. The reactor temperature is slowly brought to 140° C. to 150° C. under nitrogen purge to obtain a clear solution. Then, still under nitrogen and at 140° C. to 150° C., 0.419 kg of 1,4-butanediol (1,4-BD) is loaded from the Feed cylinder 1 into the reactor, and the resulting mixture is homogenized by continued stirring at 140° C. Subsequently, titanium(IV)tetrabutoxide catalyst is injected from Feed cylinder 2 as 34.84 gram of a 10% by weight solution in 1,4-BD (4000 ppm calculated on DMA; 3.484 g catalyst+31.36 g 1,4-BD; total content of 1,4-BD is 0.450 kg). Methanol starts distilling and the kneader temperature is increased stepwise to 180° C. over a period of 2 to 3 hours at atmospheric pressure. Methanol fraction is distilled off and collected (theoretical amount: 0.320 kg) in a cooling trap. When the major fraction of methanol is removed, the kneader pressure is stepwise decreased first to 50 mbar to 20 mbar, and then further to 5 mbar to complete the methanol removal and to initiate distillation of 1,4-BD. The pressure is further decreased to less than 1 mbar or as low as possible, until a slow-but-steady distillation of 1,4-butanediol is observed (calculated theoretical amount 0.225 kg). During this operation the temperature is raised to 190° C. to 200° C. at maximum as to avoid discoloration. When the 1,4-butanediol removal is completed, the kneader is cooled to about 150° C. and brought to atmospheric pressure under nitrogen blanket and the material is collected and allowed to solidify. After cooling, the PEA-C2C50% of Preparation 1 is milled to granules. Melt viscosity of the PEA-C2C50% of Preparation 1 is 2,200 mpa.s at 180° C. Viscosities are determined using a Brookfield DV-II+ Vicosimeter with spindle number 28 at 20 revolutions per minute (rpm). The polymer melting point is determined by DSC (peak maximum) to be 130° C. The polymer melting point is determined by DSC (peak maximum). Analysis data for PEA-C2C50% of Preparation 1 are shown below in Table 1.

TABLE 1

| | Melt viscosity* | Melting point (° C.) |
|---|---|---|
| Polymer | (mPa · s) at 180° C. | by DSC |
| PEA-C2C50% of | 2,200 | 130-135 |
| Preparation 1 | | |

*Brookfield DV-II+ Vicosimeter with spindle number 28 at 20 rpm

Physical properties obtained from compression molded plaques are presented in Table 2.

TABLE 2

| | | Tensile Strength | |
|---|---|---|---|
| Polymer | Modulus (MPa) | (MPa) | Elongation (%) |
| PEA-C2C50% of | 200 | 8 | 250 |
| Preparation 1 | | | |

### COMPARATIVE EXAMPLES

### Comparative Example 1

A melt of the polymer of Preparation 1 is electrospun directly from the melt, utilizing a NS Lab-M device manufactured by Elmarco s.r.o., Liberec, Czech Republic. The polymer is electrospun on a standard cellulose carrier material, at a melt temperature of 190° C. The resulting tissue is tested in a standard gas filtration efficiency test. Results are shown below in Table 3.

### Examples of the Present Invention

### Example 1

A melt of the polymer of Preparation 1 and 4 wt % diethylene glycol is blended. The resulting resin is then electrospun directly from the melt, using a suitable spinning machine, as an example the NS Lab-M by Elmarco. The polymer is electrospun on a standard cellulose carrier material, at a melt temperature of 190° C. The resulting tissue is tested in a standard gas filtration efficiency test and its results compared with the tissue of Comparative Example 1. Efficiency and pressure drop are determined with a Frazier Permeability tester according to ASTM D-737 and average fiber diameter is determined as described previously. The test results compare as in Table 3. Conclusion; the filter efficiency is firmly increasing while the area weight of electrospun fibers needed is dramatically reduced.

TABLE 3

| | | | | Average |
|---|---|---|---|---|
| | | | | Fiber |
| | | Pressure | Basis weight, | diameter |
| | Efficiency, % | drop, (Pa) | (g/m²) | (nm) |
| Comparative | 55 | 250 | 2.5 | 300-600 |
| Example 1 | | | | |
| Example 1 | 85 | 165 | 1.0 | 200-400 |

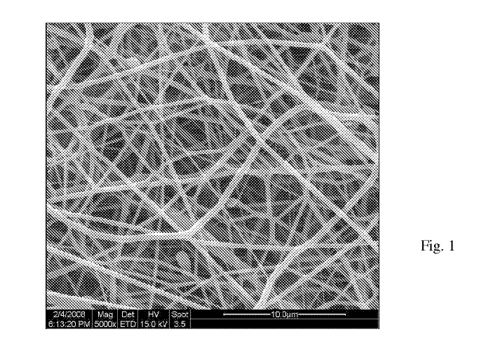

A 5000 times SEM of a fiberweb of Example 1 is shown in FIG. 1. In FIG. 1, the fiberweb is substantially free of beading.

### Examples 2 to 4

The procedure of Example 1 is repeated except instead of 4 wt % DEG, 2 wt % DEG, 6 wt % DEG, or 4 wt % glycerol, respectively, are used. Zero shear viscosities (in megaPascal.seconds or mPa.s) of the melts of the compositions comprising the polymer of Preparation 1 and the 4 wt % DEG, 2 wt % DEG, 6 wt % DEG, or 4 wt % glycerol are determined as follows. Disk shape test specimens of 25 mm diameter each are punched out of compression molded plaques and dried under vacuum at 60° C. for 24 hours and the viscosities are measured using an Advanced Rheometric Expansion System (ARES) with parallel plate setup at 180° C. under nitrogen atmosphere. Zero shear viscosities are extrapolated from dynamic frequency sweep tests in the range from 100 radians per second (rad/sec) tol 0.1 rad/sec (logarithmic mode, 10 points per decade) with the strain adjusted in the linear region from 10% to 30% in order to obtain sufficient torque level. The results are shown below in Table 4.

TABLE 4

| | Zero Shear Melt Viscosity at |
|---|---|
| Example Number | 180° C. (mPa · s) |
| Comparative | 2200 |
| Example 1 | |
| 1 | 1700 |
| 2 | 1900 |
| 3 | 1650 |
| 4 | 1500 |

While the invention has been described above according to its preferred embodiments of the present invention and examples of steps and elements thereof, it may be modified within the spirit and scope of this disclosure. This application is therefore intended to cover any variations, uses, or adaptations of the instant invention using the general principles disclosed herein. Further, this application is intended to cover such departures from the present disclosure as come within the known or customary practice in the art to which this invention pertains and which fall within the limits of the following claims.

1. A process for fabricating a fiber comprising a molecularly self-assembling material, the process comprising elongating under fiber-forming conditions a melt of a composition comprising a molecularly self-assembling material and one or more processing additives to produce one or more fibers comprising the molecularly self-assembling material, wherein the one or more processing additives comprise a total of from 1.0 weight percent (wt %) to 10 wt % of the composition and each processing additive independently is 1,1,2-trichloroethane; a (monohalo to perhalo)(C₇-C₄₀)alkyl; a (monohalo to perhalo)(C₃-C₄₀)cycloalkyl; a (monohalo to perhalo)phenyl; a (C₆-C₄₀)carboxylic ester of formula R²C(O)OR¹; a (C₆-C₄₀)carboxylic ester of formula R¹C(O)OR²; adipic acid dimethyl ester; adipic acid diethyl ester; an adipic acid dipropyl ester; maleic acid dimethyl ester; maleic acid diethyl ester; a maleic acid dipropyl ester; citric acid trimethyl ester; citric acid triethyl ester; a citric acid tripropyl ester; a (C₈-C₄₀)dicarboxylic ester of formula [R¹OC(O)](C₁-C₃)alkylene[C(O)OR²]; a (C₈-C₄₀)dicarboxylic ester of formula (C₄-C₄₀)alkylene[C(O)OR¹]₂; a (C₈-C₄₀)dicarboxylic ester of formula [R¹C(O)O](C₁-C₃)alkylene[C(O)OR²]; a (C₈-C₄₀)dicarboxylic ester of formula [R²C(O)O](C₁-C₃)alkylene[C(O)OR¹]; a (C₈-C₄₀)dicarboxylic ester of formula (C₄-C₄₀)alkylene[OC(O)R¹]₂; a (C₁₀-C₄₀)dicarboxylic ester of formula phenylene[C(O)OR¹]₂; a (C₁₀-C₄₀)dicarboxylic ester of formula [R¹C(O)O]phenylene[C(O)OR¹]; a (C₁₀-C₄₀)dicarboxylic ester of formula phenylene[OC(O)R¹]₂; a (C₁₀-C₄₀)tricarboxylic ester of formula [R¹OC(O)]₂(C₁-C₃)alkylenyl[C(O)OR²]; a (C₁₀-C₄₀)tricarboxylic ester of formula (C₄-C₄₀)alkylenyl[C(O)OR¹]₃; a (C₁₀-C₄₀)tricarboxylic ester of formula [R¹C(O)O]₂(C₁-C₃)alkylenyl[OC(O)R²]; a (C₁₀-C₄₀)tricarboxylic ester of formula (C₄-C₄₀)alkylenyl[OC(O)R¹]³; a (C₁₂-C₄₀)tricarboxylic ester of formula phenylenyl[C(O)OR¹]₃; a (C₁₂-C₄₀)tricarboxylic ester of formula [R¹C(O)O]phenylenyl[C(O)OR^{1]}₂; a (C₁₂-C₄₀)tricarboxylic ester of formula [R¹C(O)O]₂phenylenyl[C(O)OR¹]; a (C₁₂-C₄₀)tricarboxylic ester of formula phenylenyl[OC(O)R¹]₃; a (C₄-C₄₀)carboxylic acid of formula R²C(O)OH; a (C₄-C₄₀)carboxamide of formula R⁴C(O)NR⁵R⁶; a (C₃-C₄₀)alcohol of formula R⁷OH; bis(l methylethyl)ketone; a (C₄-C₄₀)ketone of formula R⁸C(O)R⁹; 1,4-dioxane; a (C₄-C₄₀)ether of formula R⁸OR⁹; ethylene glycol; a propylene glycol; a butylene glycol; a (C₅-C₄₀)glycol of formula HO—(C₅-C₄₀)alkylene-OH; diethylene glycol; triethylene glycol; tetraethylene glycol; pentaethylene glycol; a (C₁₂-C₄₀)polyethylene glycol of formula HOCH₂CH₂(—OCH₂CH₂)ₘ—OH; dipropylene glycol; tripropylene glycol; tetrapropylene glycol; pentapropylene glycol; a (C₄-C₃₉)polypropylene glycol of formula HOCH₂CH₂CH₂(—OCH₂CH₂CH₂)ₙ—OH; glycerol; a methoxyglycerol; an ethoxyglycerol; a propoxyglycerol; an ethylene glycol mono(C₄-C₄₀)alkyl ether; a propylene glycol mono(C₄-C₄₀)alkyl ether; a (C₅-C₈₀)alkylene glycol monoalkyl ether of formula (C₁-C₄₀)alkylO—(C₄-C₄₀)alkylene-OH; 1,2-dimethoxyethane; 1,2-diethoxyethane; a 1,2-dipropoxyethane; dipropylene glycol dimethyl ether; a (C₆-C₁₂₀)alkylene glycol dialkyl ether of formula (C₁-C₄₀)alkylO—(C₄-C₄₀)alkylene-O(C₁-C₄₀)alkyl; or a (C₃-C₁₂₀)triphosphate ester of formula P(O)(OR¹)₃; wherein independently for each processing additive: each m independently is an integer of from 5 to 19; each n independently is an integer of from 5 to 12; each halo independently is fluoro or chloro; each R¹ independently is (C₁-C₄₀)alkyl, (C₃-C₄₀)cycloalkyl, phenyl, or benzyl; each R² and R⁴ independently is (C₄-C₄₀)alkyl, (C₃-C₄₀)cycloalkyl, phenyl, or benzyl, or R¹ and R² are taken together form a (C₂-C₄₀)alkylene; each R⁵ and R⁶ independently is H, (C₁-C₄₀)alkyl, (C₃-C₄₀)cycloalkyl, phenyl, or benzyl, or R⁵ and R⁶ taken together form a (C₃-C₄₀)alkylene, or R⁴ and R⁵ are taken together form a (C₂-C₄₀)alkylene; each R⁷ independently is (C₄-C₄₀)alkyl, (C₃-C₄₀)cycloalkyl, phenyl, or benzyl; each R⁸ independently is (C₄-C₄₀)alkyl, (C₃-C₄₀)cycloalkyl, phenyl, or benzyl; each R⁹ independently is (C₁-C₄₀)alkyl, (C₃-C₄₀)cycloalkyl, phenyl, or benzyl, or R⁸ and R⁹ are taken together form a (C₇-C₄₀)alkylene; and each processing additive independently is unsubstituted or substituted by from 1 to 3 substituents, wherein each substituent independently is fluoro, chloro, —OH, —O(C₁-C₃)alkyl, —NH₂, —NH[(C₁-C₃)alkyl], —N[(C₁-C₃)alkyl]₂, or oxo.

2. A process of claim 1, the one or more fibers further comprising the at least one processing additive.

3. A process of claim 1, wherein the molecularly self-assembling material is selected from the group consisting of a polyester-amide, polyether-amide, polyester-urethane, polyether-urethane, polyether-urea, polyester-urea, or a mixture thereof.

4. (canceled)

5. (canceled)

6. (canceled)

7. (canceled)

8. A process of claim 1, wherein the molecularly self-assembling material comprises repeat units of formula I: 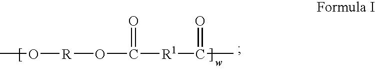
and at least one second repeat unit selected from the ester-amide units of Formula II and III: 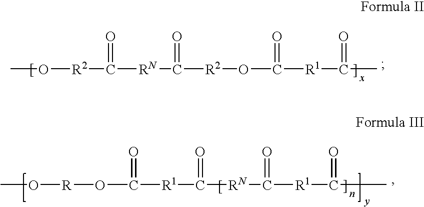
and the ester-urethane units of Formula IV: 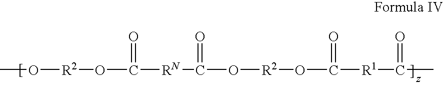
or combinations thereof wherein:
R is at each occurrence, independently a C₂-C₂₀ non-aromatic hydrocarbylene group, a C₂-C₂₀ non-aromatic heterohydrocarbylene group, or a polyalkylene oxide group having a group molecular weight of from about 100 grams per mole to about 5000 grams per mole;
R¹ at each occurrence independently is a bond or a C₁-C₂₀ non-aromatic hydrocarbylene group;
R² at each occurrence independently is a C₁-C₂₀ non-aromatic hydrocarbylene group;
R^{N} is —N(R³)—Ra—N(R³)—, where R³ at each occurrence independently is H or a C₁-C₆ alkylene and Ra is a C₂-C₂₀ non-aromatic hydrocarbylene group, or R^{N} is a C₂-C₂₀ heterocycloalkyl group containing the two nitrogen atoms, wherein each nitrogen atom is bonded to a carbonyl group according to formula (III) above;
n is at least 1 and has a mean value less than 2; and
w represents the ester mol fraction of Formula I, and x, y and z represent the amide or urethane mole fractions of Formulas II, III, and IV, respectively, where w+x+y+z=1, and 0<w<1, and at least one of x, y and z is greater than zero but less than 1.

9. A process of claim 1, wherein the molecularly self-assembling material is a polymer or oligomer of Formula II or III: 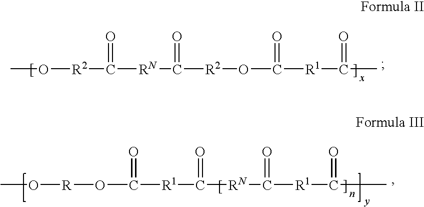
wherein
R is at each occurrence, independently a C₂-C₂₀ non-aromatic hydrocarbylene group, a C₂-C₂₀ non-aromatic heterohydrocarbylene group, or a polyalkylene oxide group having a group molecular weight of from about 100 grams per mole to about 5000 grams per mole;
R¹ at each occurrence independently is a bond or a C₁-C₂₀ non-aromatic hydrocarbylene group;
R² at each occurrence independently is a C₁-C₂₀ non-aromatic hydrocarbylene group;
R^{N} is —N(R³)—Ra—N(R³)—, where R³ at each occurrence independently is H or a C₁-C₆ alkylene and Ra is a C₂-C₂₀ non-aromatic hydrocarbylene group, or R^{N} is a C₂-C₂₀ heterocycloalkyl group containing the two nitrogen atoms, wherein each nitrogen atom is bonded to a carbonyl group according to formula (III) above;
n is at least 1 and has a mean value less than 2; and
x and y represent mole fraction wherein x+y=1, and 0≦x≦1, and 0≦y>1.

10. A process of claim 1, wherein the number average molecular weight (Mn) of the molecularly self-assembling material is between about 1000 grams per mole (g/mol) and about 50,000 g/mol, inclusive.

11. A process of claim 10, wherein the Mₙ of the molecularly self-assembling material is less than 5,000 g/mol.

12. A process of claim 1, the one or more fibers having an average diameter of from about 0.010 micrometers (μm) to about 30 μm.

13. A process of claim 12, the one or more fibers having an average diameter of from about 0.010 μm to about 1000 μm.

14. A process of claim 1, wherein each processing additive independently is 1,1,2-trichloroethane; adipic acid dimethyl ester; adipic acid diethyl ester; an adipic acid dipropyl ester; maleic acid dimethyl ester; maleic acid diethyl ester; a maleic acid dipropyl ester; citric acid trimethyl ester; citric acid triethyl ester; a citric acid tripropyl ester; bis(l-methylethyl)ketone; 1,4-dioxane; ethylene glycol; a propylene glycol; a butylene glycol; diethylene glycol; triethylene glycol; tetraethylene glycol; pentaethylene glycol; dipropylene glycol; tripropylene glycol; tetrapropylene glycol; pentapropylene glycol; glycerol; a methoxyglycerol; an ethoxyglycerol; a propoxyglycerol; 1,2-dimethoxyethane; 1,2-diethoxyethane; a 1,2-dipropoxyethane; or dipropylene glycol dimethyl ether.

15. A process of claim 1, wherein each processing additive independently is a (monohalo to perhalo)(C₇-C₄₀)alkyl; a (monohalo to perhalo)(C₃-C₄₀)cycloalkyl; a (monohalo to perhalo)phenyl; a (C₆-C₄₀)carboxylic ester of formula R²C(O)OR¹; a (C₆-C₄₀)carboxylic ester of formula R¹C(O)OR²; a (C₈-C₄₀)dicarboxylic ester of formula [R¹OC(O)](C₁-C₃)alkylene[C(O)OR²]; a (C₈-C₄₀)dicarboxylic ester of formula (C₄-C₄₀)alkylene[C(O)OR¹]₂; a (C₈-C₄₀)dicarboxylic ester of formula [R¹C(O)O](C₁-C₃)alkylene[C(O)OR²]; a (C₈-C₄₀)dicarboxylic ester of formula [R²C(O)O](C₁-C₃)alkylene[C(O)OR¹]; a (C₈-C₄₀)dicarboxylic ester of formula (C₄-C₄₀)alkylene[OC(O)R¹]₂; a (C₁₀-C₄₀)dicarboxylic ester of formula phenylene[C(O)OR¹]₂; a (C₁₀-C₄₀)dicarboxylic ester of formula [R¹C(O)O]phenylene[C(O)OR¹]; a (C₁₀-C₄₀)dicarboxylic ester of formula phenylene[OC(O)R¹]₂; a (C₁₀-C₄₀)tricarboxylic ester of formula [R¹OC(O)]₂(C₁-C₃)alkylenyl[C(O)OR²]; a (C₁₀-C₄₀)tricarboxylic ester of formula (C₄-C₄₀)alkylenyl[C(O)OR¹]₃; a (C₁₀-C₄₀)tricarboxylic ester of formula [R¹C(O)O]₂(C₁-C₃)alkylenyl[OC(O)R²]; a (C₁₀-C₄₀)tricarboxylic ester of formula (C₄-C₄₀)alkylenyl[OC(O)R¹]₃; a (C₂-C₄₀)tricarboxylic ester of formula phenylenyl[C(O)OR¹]₃; a (C₁₂-C₄₀)tricarboxylic ester of formula [R¹C(O)O]phenylenyl[C(O)OR¹]₂; a (C₁₂-C₄₀)tricarboxylic ester of formula [R¹C(O)O]₂phenylenyl[C(O)OR¹]; a (C₁₂-C₄₀)tricarboxylic ester of formula phenylenyl[OC(O)R¹]₃; a (C₄-C₄₀)carboxylic acid of formula R²C(O)OH; a (C₄-C₄₀)carboxamide of formula R⁴C(O)NR⁵R⁶; a (C₃-C₄₀)alcohol of formula R⁷OH; a (C₄-C₄₀)ketone of formula R⁸C(O)R⁹; a (C₄-C₄₀)ether of formula R⁸OR⁹; a (C₅-C₄₀)glycol of formula HO—(C₅-C₄₀)alkylene-OH; a (C₁₂-C₄₀)polyethylene glycol of formula HOCH₂CH₂(—OCH₂CH₂)ₘ—OH; a (C₄-C₃₉)polypropylene glycol of formula HOCH₂CH₂CH₂(—OCH₂CH₂CH₂)ₙ—OH; an ethylene glycol mono(C₄-C₄₀)alkyl ether; a propylene glycol mono(C₄-C₄₀)alkyl ether; a (C₅-C₈₀)alkylene glycol monoalkyl ether of formula (C₁-C₄₀)alkylO—(C₄-C₄₀)alkylene-OH; a (C₆-C₁₂o)alkylene glycol dialkyl ether of formula (C₁-C₄₀)alkylO—(C₄-C₄₀)alkylene-O(C₁-C₄₀)alkyl; or a (C₃-C₁₂₀)triphosphate ester of formula P(O)(OR¹)₃.

16. A process of claim 15, wherein at least one of the one or more processing additives independently is a butanol, a pentanol, a hexanol, a heptanol, an octanol, benzyl alcohol, a polyethylene glycol having an average molecular weight of about 200 grams per mole (g/mol), or a polypropylene glycol having an average molecular weight of about 400 g/mol.

17. A process of claim 1, the number of carbon atoms in each processing additive independently being 10 or more.

18. A process of claim 1, wherein the one or more processing additives comprises a total of from 2 weight percent (wt %) to 6 wt % of the composition.

19. A process of claim 1, wherein the melt of the composition is characterized as having a viscosity that is less than a viscosity of a melt consisting essentially of the molecularly self-assembling material, wherein each viscosity is determined at a temperature that is the higher of 10 degrees Celsius above glass transition temperature (T_{g}) or above melting temperature (Tₘ) of the molecularly self-assembling material without any processing additive.

20. A process of claim 19, wherein the viscosity of the melt of the composition is more than 5 percent lower than the viscosity of the melt consisting essentially of the molecularly self-assembling material.

21. A process according to claim 1, wherein the molecularly self-assembling material is characterized by a melt viscosity of less than 100 pascal-seconds (Pa.s.) at from above melting temperature (Tₘ) of the molecularly self-assembling material up to about 40 degrees Celsius above the Tₘ.

22. (canceled)

23. A process according to claim 1, wherein the molecularly self-assembling material is characterized by a melt viscosity in the range of from 0.1 pascal-seconds (Pa.s.) to 30 Pa.s. in the temperature range of from 180 degrees Celsius to 220 degrees Celsius.

24. A process according to claim 1, wherein the molecularly self-assembling material is characterized by a melt viscosity having Newtonian viscosity over the frequency range of 10⁻¹ to 10² radians per second at a temperature from above melting temperature (Tₘ) of the molecularly self-assembling material up to about 40 degrees Celsius above Tₘ.

25. (canceled)

26. A process according to claim 1, wherein the molecularly self-assembling material is characterized by at least one melting temperature (Tₘ) that is greater than 25 degrees Celsius.

27. (canceled)
